(19) United States
(12) Patent Application Publication
(10) Pub. No.: US 2026/0343387 A1
(43) Pub. Date: Oct. 29, 2026

(54) INFORMATION CONFIGURATION METHOD AND APPARATUS

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 19/142,699

(22) PCT Filed: Dec. 28, 2022
(86) PCT No.: PCT/CN2022/143015

§ 371 Date: Jun. 24, 2025

(51) Int. Cl. H04W 48/16; H04W 64/00; H04W 84/06

(52) U.S. Cl. CPC H04W 48/16; H04W 64/006; H04W 84/06

(57) ABSTRACT

The present disclosure relates to the technical field of mobile communications, and provides an information configuration method and apparatus. In the method, a user equipment (UE) is allowed to cooperate with a first entity and a resource requester to perform UE unreachability information configuration authorization on the basis of an OAuth 2.0 standard framework so as to trigger the first entity to send an access token to the resource requester, the access token comprising UE unreachability duration information. According to the solution provided by the present disclosure, a core network is allowed to authorize a resource requester to configure UE unreachability information.

### TECHNICAL FIELD

The present disclosure relates to the field of mobile communication technologies and, in particular, to an information configuration method and apparatus.

### BACKGROUND

In non-terrestrial network (NTN) scenarios, unreachability information of a user equipment (UE) is not determined by a core network element itself, but is obtained from a relevant function or entity. However, there is currently no mechanism that allows the core network to authorize the relevant function or entity to configure the UE unreachability information.

### SUMMARY

The present disclosure proposes an information configuration method and apparatus, enabling a core network to authorize a resource requester to be allowed to configure UE unreachability information.

A first aspect of embodiments of the present disclosure provides an information configuration method. The method is performed by a UE, and includes triggering, by performing UE unreachability information configuration authorization through collaborating with a first entity and a resource requester, the first entity to send an access token to the resource requester, where the access token includes UE unreachability period information.

In an optional embodiment of the present disclosure, performing the UE unreachability information configuration authorization through collaborating with the first entity and the resource requester includes performing, based on an open authorization (OAuth) 2.0 standard framework, the UE unreachability information configuration authorization through collaborating with the first entity and the resource requester.

In an optional embodiment of the present disclosure, the access token includes at least one of: an identification of the UE, an identification of the first entity, an identification of the resource requester, an identification of a network exposure function (NEF), an identification of an application programming interface (API) exposing function (AEF), a service identification, an identification of a service operation allowed to act on the UE unreachability period information, and an expiration time.

In an optional embodiment of the present disclosure, the method further includes receiving a UE unreachability information configuration authorization request sent by the resource requester, where the UE unreachability information configuration authorization request includes at least one of: an identification of the resource requester, an identification of the UE, an identification of a requested service, and an identification of a service operation requested to act on the UE unreachability period information.

In an optional embodiment of the present disclosure, performing the UE unreachability information configuration authorization through collaborating with the first entity and the resource requester includes performing, by using an authorization code grant type, real-time authorization on the UE unreachability information configuration authorization request.

In an optional embodiment of the present disclosure, the method further includes sending authorization information to the first entity, where the authorization information is used for determining whether the resource requester is capable of configuring the UE unreachability period information for the UE, and the authorization information includes at least one of: an identification of the resource requester, an identification of an allowed service, an identification of the UE, the UE unreachability period information, an expiration time, and an identification of a service operation allowed to act on the UE unreachability period information.

In an optional embodiment of the present disclosure, performing the UE unreachability information configuration authorization through collaborating with the first entity and the resource requester includes performing, by using a client credentials grant type, authorization on a UE unreachability information configuration authorization request.

In an optional embodiment of the present disclosure, the UE unreachability period information includes at least one of: information about a maximum latency, information about a maximum response, information about time when the UE is provided with signal coverage, and information about time when the UE is out of signal coverage.

A second aspect of the embodiments of the present disclosure provides an information configuration method. The method is performed by a first entity, and includes sending, by performing UE unreachability information configuration authorization through collaborating with a resource requester and a UE, an access token to the resource requester, where the access token includes UE unreachability period information.

In an optional embodiment of the present disclosure, performing the UE unreachability information configuration authorization through collaborating with the resource requester and the UE includes performing, based on an OAuth 2.0 standard framework, the UE unreachability information configuration authorization through collaborating with the resource requester and the UE.

In an optional embodiment of the present disclosure, sending, by performing the UE unreachability information configuration authorization through collaborating with the resource requester and the UE, the access token to the resource requester includes sending, based on an authorization code grant type, the access token to the resource requester.

In an optional embodiment of the present disclosure, the method further includes receiving authorization information sent by the UE, and receiving a UE unreachability information configuration authorization request sent by the resource requester; where sending, by performing the UE unreachability information configuration authorization through collaborating with the resource requester and the UE, the access token to the resource requester includes sending the access token to the resource requester through performing based on the authorization information, by using a client credentials grant type, authorization on the UE unreachability information configuration authorization request; and the authorization information is used for determining whether the resource requester is capable of configuring the UE unreachability information for the UE, and the authorization information includes at least one of: an identification of the resource requester, an identification of the UE, an identification of an allowed service, the UE unreachability period information, an identification of a service operation allowed to act on the UE unreachability period information, and an expiration time.

In an optional embodiment of the present disclosure, the method further includes: sending a refresh token to the resource requester; receiving an access token request sent by the resource requester, where the access token request is used for requesting the access token; and sending, in response to the access token request, the access token to the resource requester.

In an optional embodiment of the present disclosure, the access token includes at least one of: an identification of the first entity, an identification of the resource requester, an identification of the UE, an identification of an NEF, an identification of an API exposing function (AEF), a service identification, an identification of a service operation allowed to act on the UE unreachability period information, and an expiration time.

A third aspect of the embodiments of the present disclosure provides an information configuration method. The method is performed by a resource requester, and includes obtaining an access token by performing UE unreachability information configuration authorization through collaborating with a first entity and a UE, where the access token includes UE unreachability period information.

In an optional embodiment of the present disclosure, performing the UE unreachability information configuration authorization through collaborating with the first entity and the UE includes performing, based on an OAuth 2.0 standard framework, the UE unreachability information configuration authorization through collaborating with the first entity and the UE.

In an optional embodiment of the present disclosure, the method further includes sending a UE unreachability information configuration authorization request to the UE, where the UE unreachability information configuration authorization request includes at least one of: an identification of the resource requester, an identification of the UE, an identification of a requested service, the UE unreachability period information, and an identification of a service operation requested to act on the UE unreachability period information.

In an optional embodiment of the present disclosure, the method further includes sending a UE unreachability information configuration authorization request to the first entity.

In an optional embodiment of the present disclosure, the method further includes: sending a UE unreachability information configuration request to a resource server, where the UE unreachability information configuration request includes the access token; and receiving a UE information configuration response sent by the resource server.

In an optional embodiment of the present disclosure, receiving the UE information configuration response sent by the resource server includes: receiving an authorization response of the resource server to the UE unreachability information configuration request; or receiving a rejection response of the resource server to the UE unreachability information configuration request and a reason for rejection.

In an optional embodiment of the present disclosure, the method further includes: receiving a refresh token sent by the first entity; sending an access token request to the first entity, where the access token request is used for requesting the access token, and receiving the access token sent by the first entity in response to the access token request.

In an optional embodiment of the present disclosure, the access token includes at least one of: an identification of the UE, an identification of the first entity, an identification of the resource requester, an identification of an NEF, an identification of an AEF, a service identification, an identification of a service operation allowed to act on the UE unreachability period information, and an expiration time.

In an optional embodiment of the present disclosure, the resource requester is an application function (AF).

A fourth aspect of the embodiments of the present disclosure provides an information configuration method. The method is performed by a resource server, and includes: receiving a UE unreachability information configuration request sent by a resource requester, where the UE unreachability information configuration request includes an access token, and the access token includes UE unreachability period information; and sending, based on the access token, a UE information configuration response to the resource requester.

In an optional embodiment of the present disclosure, sending, based on the access token, the UE information configuration response to the resource requester includes: sending, to the resource requester, an authorization response to the UE unreachability information configuration request; or sending, to the resource requester, a rejection response to the UE unreachability information configuration request and a reason for rejection.

A fifth aspect of the embodiments of the present disclosure provides an information configuration apparatus. The apparatus is configured in a UE, and includes an authorization module. The authorization module is configured to trigger, by performing UE unreachability information configuration authorization through collaborating with a first entity and a resource requester, the first entity to send an access token to the resource requester, where the access token includes UE unreachability period information.

A sixth aspect of the embodiments of the present disclosure provides an information configuration apparatus. The apparatus is configured in a first entity, and includes an authorization module. The authorization module is configured to send, by performing UE unreachability information configuration authorization through collaborating with a resource requester and a UE, an access token to the resource requester, where the access token includes UE unreachability period information.

A seventh aspect of the embodiments of the present disclosure provides an information configuration apparatus. The apparatus is configured in a resource requester, and includes an authorization module. The authorization module is configured to obtain an access token by performing UE unreachability information configuration authorization through collaborating with a first entity and a UE, where the access token includes UE unreachability period information.

An eighth aspect of the embodiments of the present disclosure provides an information configuration apparatus. The apparatus is configured in a resource server, and includes a transceiver module. The transceiver module is configured to: receive a UE unreachability information configuration request sent by a resource requester, where the UE unreachability information configuration request includes an access token, and the access token includes UE unreachability period information; and send, based on the access token, a UE information configuration response to the resource requester.

A ninth aspect of the embodiments of the present disclosure provides a communication device including a transceiver, a memory, and a processor that is connected to the transceiver and the memory respectively, and is configured to, through executing a computer-executable instruction in the memory, control transceiving of a wireless signal of the transceiver, and be capable of implementing the method of any one of the embodiments in the first aspect to the fourth aspect.

A tenth aspect of the embodiments of the present disclosure provides a computer storage medium, where the computer storage medium stores a computer-executable instruction, and the computer-executable instruction, when executed by a processor, is capable of implementing the method of any one of the embodiments in the first aspect to the fourth aspect.

An eleventh aspect of the embodiments of the present disclosure provides a communication system including a UE, a resource requester, a first entity, and a resource server, where the UE is configured to perform the method of any one of the embodiments in the first aspect, the first entity is configured to perform the method of any one of the embodiments in the second aspect, the resource requester is configured to perform the method of any one of the embodiments in the third aspect, and the resource server is configured to perform the method of any one of the embodiments in the fourth aspect.

The embodiments of the present disclosure provide an information configuration method and apparatus, where the UE collaborates with the first entity and the resource requester to perform the UE unreachability information configuration authorization, thereby triggering the first entity to send the access token to the resource requester, where the access token includes the UE unreachability period information. The schemes provided in the present disclosure achieve that the core network is allowed to authorize the resource requester to configure the UE unreachability information.

Additional aspects and advantages of the present disclosure will be given, in part, in the following description, in part as will become apparent from the following description, or as will be learned through practice of the present disclosure.

### BRIEF DESCRIPTION OF THE DRAWINGS

The foregoing and/or additional aspects and advantages of the present disclosure will become apparent and readily understood from the following description of the embodiments in conjunction with the accompanying drawings.

FIG. 1 is a schematic flow diagram of an information configuration method according to an embodiment of the present disclosure.

FIG. 2 is a schematic flow diagram of an information configuration method according to an embodiment of the present disclosure.

FIG. 3 is a schematic flow diagram of an information configuration method according to an embodiment of the present disclosure.

FIG. 4 is a schematic flow diagram of an information configuration method according to an embodiment of the present disclosure.

FIG. 5 is a schematic flow diagram of an information configuration method according to an embodiment of the present disclosure.

FIG. 6 is a schematic flow diagram of an information configuration method according to an embodiment of the present disclosure.

FIG. 7 is a schematic flow diagram of an information configuration method according to an embodiment of the present disclosure.

FIG. 8 is a schematic flow diagram of an information configuration method according to an embodiment of the present disclosure.

FIG. 9 is a schematic flow diagram of an information configuration method according to an embodiment of the present disclosure.

FIG. 10 is a schematic flow diagram of an information configuration method according to an embodiment of the present disclosure.

FIG. 11 is a schematic flow diagram of an information configuration method according to an embodiment of the present disclosure.

FIG. 12 is a schematic flow diagram of an information configuration method according to an embodiment of the present disclosure.

FIG. 13 is a schematic interaction diagram of an information configuration method according to an embodiment of the present disclosure.

FIG. 14 is a schematic interaction diagram of an information configuration method according to an embodiment of the present disclosure.

FIG. 15 is a block diagram of an information configuration apparatus according to an embodiment of the present disclosure.

FIG. 16 is a block diagram of an information configuration apparatus according to an embodiment of the present disclosure.

FIG. 17 is a block diagram of an information configuration apparatus according to an embodiment of the present disclosure.

FIG. 18 is a block diagram of an information configuration apparatus according to an embodiment of the present disclosure.

FIG. 19 is a block diagram of an information configuration apparatus according to an embodiment of the present disclosure.

FIG. 20 is a block diagram of an information configuration apparatus according to an embodiment of the present disclosure.

FIG. 21 is a block diagram of an information configuration apparatus according to an embodiment of the present disclosure.

FIG. 22 is a schematic structure diagram of a communication device provided in an embodiment of the present disclosure.

FIG. 23 is a schematic structure diagram of a chip provided in an embodiment of the present disclosure.

### DETAILED DESCRIPTION

The embodiments of the present disclosure are described in detail below, and examples of the embodiments are shown in the accompanying drawings, where the same or similar numerals throughout indicate the same or similar elements or elements having the same or similar functions. The embodiments described below with reference to the accompanying drawings are exemplary and are intended to be used for explaining the present disclosure, but are not to be construed as a limitation of the present disclosure.

In NTN scenarios, an access and mobility management function (AMF) in a 5G core network (5GC) or a mobility management entity (MME) in a 4G core network (EPC) does not self-determine a UE unreachability period, but obtains the UE unreachability period from an application function (AF), a UE, or an operation and maintenance system. If the UE unreachability period information is provided by the AF, it is required to determine whether the AF has authorization to provide unreachability period information for a certain UE. In related arts, authorization based on open authorization (OAuth) 2.0 may be used for authorizing an AF according to a network defined in TS 33.501 [1], however, the authorization is an authorization based on a service level, but not an authorization based on the level of the respective UE.

If an AF authorized for a satellite access service provides the 5GC/EPC with the unreachability period information of the UE that is not under its authority, the 5GC/EPC may be misled to place, when the UE is still within a satellite coverage range, the UE in a CM-CONNECTED connected state in a CM-IDLE idle state, which may result in a service interruption; or the 5GC/EPC may be misled to provide the UE with an inappropriate mobility management parameter and/or power saving parameter, resulting in failure to optimize power consumption. Both the above cases result in denial of service (DOS) attacks on the UE.

However, the mechanism in the related arts that allows the core network to authorize the AF to configure the UE unreachability information is unclear.

In view of this, the present disclosure proposes an information configuration method and apparatus, providing schemes related to configuring the core network to authorize the AF to provide unreachability time information.

The information configuration method and apparatus provided in the present application are described in detail below in conjunction with the accompanying drawings.

It can be understood that the schemes provided in the present disclosure may be used in a fourth generation mobile communication technology (4G) and its subsequent communication technologies, such as a fifth generation mobile communication technology (5G), a fifth generation mobile communication technology evolution (5G-advanced), a sixth generation mobile communication technology (6G), and the like, which is not limited in the present disclosure.

FIG. 1 shows a schematic flow diagram of an information configuration method according to an embodiment of the present disclosure. The method may be performed by a UE. As shown in FIG. 1, the method may include the following step S101.

At S101, the UE performs UE unreachability information configuration authorization through collaborating with a first entity and a resource requester, thereby triggering the first entity to send an access token to the resource requester.

In some embodiments, the access token includes UE unreachability period information, which is not limited in the present disclosure. In an optional embodiment, the UE unreachability period information included in the access token is used for indicating that a resource allowed by the token for operation by the resource requester is the UE unreachability period information.

It should be understood that the access token at least includes the UE unreachability period information. The access token may further include other information, which is not limited in this embodiment.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In an optional embodiment of the present disclosure, the manner in which the UE performs the UE unreachability information configuration authorization through collaborating with the first entity and the resource requester is not limited in the present disclosure. In an optional embodiment, the UE may perform, based on an open authorization (OAuth) 2.0 standard framework, the UE unreachability information configuration authorization through collaborating with the first entity and the resource requester. The UE may also perform, based on another framework, the UE unreachability information configuration authorization through collaborating with the first entity and the resource requester, which is not limited in the present disclosure.

In an optional embodiment of the present disclosure, the resource requester may be an AF, a UE, or an operation and maintenance system. The AF is illustrated as an example in the present disclosure, but does not constitute a limitation of other possible functions or entities of the resource requester.

In an optional embodiment of the present disclosure, the first entity may be a common application programming interface (API) framework (common API framework, CAPIF) core function (CAPIF core function, CCF) or an authorization function, or may be other core network functions, such as a network exposure function (NEF). The CAPIF/authorization function is illustrated as an example in the present disclosure, but does not constitute a limitation of other possible functions or entities of the first entity.

In summary, in an optional embodiment of the present disclosure, according to the information configuration method provided in the present disclosure, the UE may perform the UE unreachability information configuration authorization through collaborating with the first entity and the resource requester, thereby triggering the first entity to send the access token to the resource requester, where the access token includes the UE unreachability period information. The schemes provided in the present disclosure achieve that the core network is allowed to authorize the resource requester to configure the UE unreachability information.

In some optional embodiments of the present disclosure, taking the OAuth 2.0 standard framework as an example, there are two authorization mechanisms, which are collectively referred to in the present disclosure as that the resource requester, the first entity, and the UE collaborate based on the OAuth 2.0 standard framework to perform the UE unreachability information configuration authorization. Upon authorization, the first entity is capable of sending the access token to the resource requester, thereby authorizing the resource requester to configure the UE unreachability information. Based on the embodiment shown in FIG. 1, the following respectively describes, through the embodiments shown in FIGS. 2 and 3, the two authorization mechanisms under the OAuth 2.0 standard framework proposed in the present disclosure.

FIG. 2 shows a schematic flow diagram of an information configuration method according to an embodiment of the present disclosure. The method may be performed by the UE. Based on the embodiment shown in FIG. 1, the embodiment shown in FIG. 2 illustrates a first authorization mechanism in which the resource requester sends a request to the UE. Specifically, the method may include the following steps S201 to S202.

At S201, a UE unreachability information configuration authorization request sent by the resource requester is received.

In a specific embodiment of the present disclosure, the UE may receive the UE unreachability information configuration authorization request sent by the AF.

In an optional embodiment of the present disclosure, the UE unreachability information configuration authorization request may include at least one of the following: an identification of the resource requester, an identification of the UE, an identification of a requested service, the UE unreachability period information, and an identification of a service operation requested to act on the UE unreachability period information.

In an optional embodiment of the present disclosure, the UE unreachability period information included in the UE unreachability information configuration authorization request is used for indicating that the resource requested by the resource requester for configuration is the UE unreachability period information.

In some optional embodiments, the UE has other information such as quality of service (QoS) information, UE related 5GC assistance information, etc. that may be requested by the AF for exposure or configuration, which is not limited in the present disclosure.

In an optional embodiment of the present disclosure, the service identification may include Nnef_ParameterProvision.

In an optional embodiment of the present disclosure, the identification of the service operation may include at least one of the following: Nnef_ParameterProvision_Update service operation, Nnef_ParameterProvision_Create service operation, Nnef ParameterProvision Delete service operation, Nnef_ParameterProvision_Get service operation.

In some specific embodiments, the UE unreachability information configuration authorization request may include different contents in different cases.

1) In a case where the resource requester has obtained the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), and the UE unreachability period information.

2) In a case the resource requester does not obtain the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), the identification of the requested service (e.g., Nnef_ParameterProvision), the identification of the service operation requested to act on the UE unreachability period information (e.g., Nnef ParameterProvision_Update service operation, Nnef_ParameterProvision_Create service operation, Nnef ParameterProvision_Delete service operation, Nnef_ParameterProvision_Get service operation), and the UE unreachability period information.

In an optional embodiment of the present disclosure, the UE unreachability period information included in the UE unreachability information configuration authorization request is used for indicating that the resource requested by the resource requester for configuration is the UE unreachability period information.

In an optional embodiment of the present disclosure, the identification of the requested service may include at least one of the following: a service name identifier (Service Name), a service operation identifier (Service Operation), an operation semantics identifier (Operation Semantics), an API identifier.

In some optional embodiments of the present disclosure, before the resource requester AF sends the request to the UE, the AF and the UE need to authenticate each other, which is not described herein.

At S202, the UE performs real-time authorization, by using an authorization code grant type, on the UE unreachability information configuration authorization request.

In an optional embodiment of the present disclosure, when the AF sends the authorization request to the UE, the AF, the UE, and the CCF/authorization function need to perform the UE unreachability information configuration authorization based on the OAuth 2.0. Optionally, this embodiment uses the authorization code grant type, where the UE can authorize the request in a timely and real-time manner to trigger the first entity to send the access token to the resource requester, and the access token includes the UE unreachability period information. In this case, the UE, the AF, and the CCF/authorization function serve as the resource owner, the client, and the authorization server respectively.

In an optional embodiment of the present disclosure, the access token may include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an API exposing function (AEF) (e.g., NFInstance ID, NF ID), a service identification (optional), an identification of the UE, the UE unreachability period information, an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a generic public subscription identifier (GPSI), an international mobile subscriber identity (IMSI), an application layer ID, etc., which is not limited in the present disclosure. When the access token includes the identification of the UE, allowing the core network to authorize the resource requester to configure the UE unreachability information related to a specific UE can be achieved.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In summary, according to the information configuration method provided in the present disclosure, the UE can receive the UE unreachability information configuration authorization request sent by the resource requester, and the UE can perform, by applying the authorization code grant type, the real-time authorization on the UE unreachability information configuration authorization request, thereby triggering the first entity to send the access token to the resource requester. The schemes provided in the present disclosure achieve that the core network is allowed to authorize the resource requester to configure the UE unreachability information.

FIG. 3 shows a schematic flow diagram of an information configuration method according to an embodiment of the present disclosure. The method may be performed by the UE. Based on the embodiment shown in FIG. 1, the embodiment shown in FIG. 3 illustrates a second authorization mechanism in which the resource requester sends a request to the first entity, and the UE participates in it. Specifically, the method may include the following steps S301 to S302.

At S301, authorization information is sent to the first entity.

In some embodiments, the authorization information is used for determining whether the resource requester is capable of configuring the UE unreachability period information for the UE. In an optional embodiment of the present disclosure, the authorization information may include at least one of the following: an identification of the resource requester, an identification of the UE, an identification of an allowed service, the UE unreachability period information, an expiration time, and an identification of a service operation allowed to act on the UE unreachability period information.

In an optional embodiment of the present disclosure, the UE unreachability period information included in the authorization information is used for indicating that the resource allowed by the authorization information for operation by the resource requester is the UE unreachability period information.

In an embodiment of the present disclosure, the resource requester AF may send a UE unreachability information configuration authorization request to the first entity CCF/authorization function.

Under this authorization mechanism, the UE needs to send the authorization information to the first entity CCF/authorization function. The authorization information is used for determining whether a specific AF is capable of providing specific information. In an optional embodiment of the present disclosure, the authorization information may include at least one of the following: the identification of the resource requester AF (e.g., AF_ID, application layer ID, fully qualified domain name (FQDN)), the identification of the UE (e.g., subscription permanent identifier (SUPI), subscription concealed identifier (SUCI), IMS private user identity (IP multimedia private identity, IMPI), UE application layer ID, GPSI), the UE unreachability period information, the expiration time (or expiration), and the identification of the service operation allowed to act on the UE unreachability period information. It should be noted that the UE unreachability period information herein is used for indicating that the resource allowed by the authorization information for operation by the resource requester is the UE unreachability period information. In some optional embodiments, the UE has other information such as QoS information, UE related 5GC assistance information, etc. that may be requested by the AF for exposure or configuration, which is not limited in the present disclosure.

In an optional embodiment of the present disclosure, before the request is sent, the first entity CCF/authorization function and the resource requester AF need to authenticate each other, which is not described herein.

At S302, the UE performs authorization, by using a client credentials grant type, on the UE unreachability information configuration authorization request.

In an optional embodiment of the present disclosure, when the AF sends the authorization request to the CCF/authorization function, the AF and the CCF/authorization function need to perform the UE unreachability information configuration authorization based on the OAuth 2.0. Optionally, this embodiment uses the client credentials grant type to trigger the first entity to send the access token to the resource requester. The AF and the CCF/authorization function serve as the client and the authorization server respectively.

In an optional embodiment of the present disclosure, the access token may include at least one of the following: an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of the UE, the UE unreachability period information, an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In summary, according to the information configuration method provided in the present disclosure, under the authorization mechanism in which the resource requester sends the authorization request to the first entity, the UE can send the authorization information to the first entity, thereby triggering the first entity to send the access token to the resource requester. The schemes provided in the present disclosure achieve that the core network is allowed to authorize the resource requester to configure the UE unreachability information.

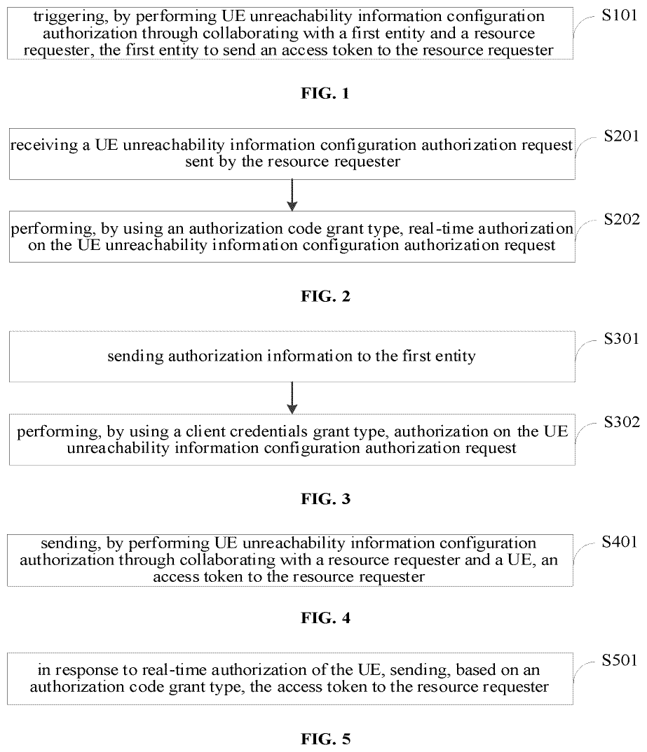

FIG. 4 shows a schematic flow diagram of an information configuration method according to an embodiment of the present disclosure. The method may be performed by a first entity. Specifically, as described above, the first entity may be a CCF or an authorization function. As shown in FIG. 4, the method may include the following step S401.

At S401, the first entity sends an access token, by performing UE unreachability information configuration authorization through collaborating with a resource requester and a UE, to the resource requester.

In some embodiments, the access token includes UE unreachability period information. In an optional embodiment, the UE unreachability period information included in the access token is used for indicating that a resource allowed by the token for operation by the resource requester is the UE unreachability period information.

It should be understood that the access token at least includes an identification of the UE, and the UE unreachability period information. The access token may further include other information, which is not limited in this embodiment.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In an optional embodiment of the present disclosure, the manner in which the first entity performs the UE unreachability information configuration authorization through collaborating with the UE and the resource requester is not limited in the present disclosure. In an optional embodiment, the first entity may perform, based on an OAuth 2.0 standard framework or another framework, the UE unreachability information configuration authorization through collaborating with the UE and the resource requester, which is not limited in the present disclosure.

In an optional embodiment of the present disclosure, the resource requester may be an AF.

In summary, according to the information configuration method provided in the present disclosure, the first entity can perform the UE unreachability information configuration authorization through collaborating with the resource requester and the UE, thereby sending the access token to the resource requester, where the access token includes the UE unreachability period information. The schemes provided in the present disclosure achieve that the core network is allowed to authorize the resource requester to configure the UE unreachability information.

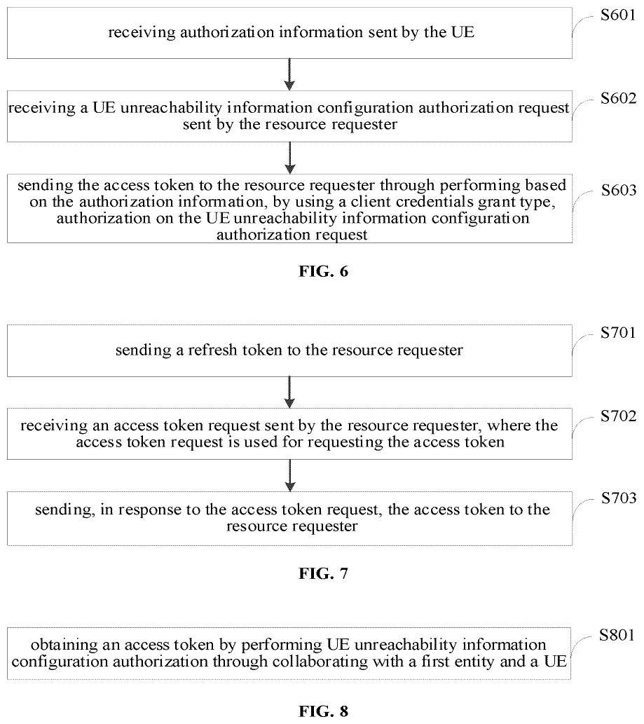

In some optional embodiments of the present disclosure, taking the OAuth 2.0 standard framework as an example, there are two authorization mechanisms, which are collectively referred to in the present disclosure as that the resource requester, the first entity, and the UE collaborate based on the OAuth 2.0 standard framework to perform the UE unreachability information configuration authorization. Upon authorization, the first entity is capable of sending the access token to the resource requester, thereby authorizing the resource requester to configure the UE unreachability information. Corresponding to FIGS. 2 and 3, and based on the embodiment shown in FIG. 4, the following respectively describes, through FIGS. 5 and 6, the two authorization mechanisms under the OAuth 2.0 standard framework proposed in the present disclosure.

FIG. 5 shows a schematic flow diagram of an information configuration method according to an embodiment of the present disclosure. The method may be performed by the first entity. Based on the embodiment shown in FIG. 4, the embodiment shown in FIG. 5 illustrates a first authorization mechanism in which the resource requester sends a request to the UE. Specifically, the method may include the following step S501.

At S501, the access token is sent to the resource requester based on an authorization code grant type.

In a specific embodiment of the present disclosure, the resource requester AF may send the UE unreachability information configuration authorization request to the UE, and the UE may use the authorization code grant type to perform real-time authorization on the request. In response to the real-time authorization of the UE, the first entity may send the access token to the resource requester AF.

In an optional embodiment of the present disclosure, before the resource requester sends the request to the UE, the AF and the UE need to authenticate each other, which is not described herein.

In an optional embodiment of the present disclosure, when the AF sends the authorization request to the UE, the AF, the UE, and the CCF/authorization function need to perform the UE unreachability information configuration authorization based on the OAuth 2.0. Optionally, this embodiment uses the authorization code grant type, where the UE can authorize the request in a timely and real-time manner to trigger the first entity to send the access token to the resource requester, and the access token includes the UE unreachability period information. In this case, the UE, the AF, and the CCF/authorization function serve as the resource owner, the client, and the authorization server respectively.

In an optional embodiment of the present disclosure, the access token may include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In summary, according to the information configuration method provided in the present disclosure, for the authorization mechanism in which the resource requester sends the UE unreachability information configuration authorization request to the UE, the first entity can send the access token to the resource requester based on the authorization code grant type, thereby sending the access token to the resource requester, where the access token includes the UE unreachability period information. The schemes provided in the present disclosure achieve that the core network is allowed to authorize the resource requester to configure the UE unreachability information.

FIG. 6 shows a schematic flow diagram of an information configuration method according to an embodiment of the present disclosure. The method may be performed by the first entity. Based on the embodiment shown in FIG. 4, the embodiment shown in FIG. 6 illustrates a second authorization mechanism in which the resource requester sends a request to the first entity, and the UE participates in it. Specifically, the method may include the following steps S601 to S603.

At S601, authorization information sent by the UE is received.

In an optional embodiment of the present disclosure, the authorization information is used for determining whether the resource requester is capable of configuring the UE unreachability information for the UE. In an optional embodiment, the authorization information may include at least one of the following: an identification of the resource requester, an identification of the UE, an identification of an allowed service, the UE unreachability period information, an identification of a service operation allowed to act on the UE unreachability period information, and an expiration time.

In an optional embodiment of the present disclosure, the UE unreachability period information included in the authorization information is used for indicating that the resource allowed by the authorization information for operation by the resource requester is the UE unreachability period information. In some optional embodiments, the UE has other information such as QoS information, UE related 5GC assistance information, etc. that may be requested by the AF for exposure or configuration, which is not limited in the present disclosure.

At S602, the UE unreachability information configuration authorization request sent by the resource requester is received.

It should be understood that the execution order of steps S601 and S602 is not limited in the present disclosure.

At S603, the first entity sends the access token to the resource requester through performing based on the authorization information,, by using a client credentials grant type, authorization on the UE unreachability information configuration authorization request.

In an optional embodiment of the present disclosure, the resource requester AF may send the UE unreachability information configuration authorization request to the first entity CCF/authorization function.

Under this authorization mechanism, the UE needs to send the authorization information to the first entity CCF/authorization function. The authorization information is used for determining whether a specific AF is capable of providing specific information. In an optional embodiment, the authorization information may include at least one of the following: the identification of the resource requester AF (e.g., AF_ID, application layer ID, fully qualified domain name (FQDN)), the identification of the UE (e.g., SUPI, SUCI, IMPI, UE application layer ID, GPSI), the UE unreachability period information, the expiration time (or expiration), and the identification of the service operation allowed to act on the UE unreachability period information. It should be noted that the UE unreachability period information herein is used for indicating that the resource allowed by the authorization information for operation by the resource requester is the UE unreachability period information. In some optional embodiments, the UE has other information such as QoS information, UE related 5GC assistance information, etc. that may be requested by the AF for exposure or configuration, which is not limited in the present disclosure.

In an optional embodiment of the present disclosure, before the request is sent, the first entity CCF/authorization function and the resource requester AF need to authenticate each other, which is not described herein.

In an optional embodiment of the present disclosure, when the AF sends the authorization request to the CCF/authorization function, the AF and the CCF/authorization function need to perform the UE unreachability information configuration authorization based on the OAuth 2.0, thereby causing the first entity to send the access token to the resource requester, where the access token includes the UE unreachability period information. The AF and the CCF/authorization function serve as the client and the authorization server respectively.

In an optional embodiment of the present disclosure, the access token may include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage. In summary, according to the information configuration method provided in the present disclosure, under the authorization mechanism in which the resource requester sends the authorization request to the first entity, the first entity can receive the UE unreachability information configuration authorization request sent by the resource requester, and the authorization information sent by the UE, causing the first entity, based on the authorization information, to perform the authorization on the UE unreachability information configuration authorization request by using the client credentials grant type, thereby sending the access token to the resource requester, where the access token includes the UE unreachability period information. The schemes provided in the present disclosure achieve that the core network is allowed to authorize the resource requester to configure the UE unreachability information.

As an optional embodiment, FIG. 7 shows a schematic flow diagram of an information configuration method according to an embodiment of the present disclosure. The method may be performed by the first entity. Based on the embodiment shown in FIG. 4, the embodiment shown in FIG. 7 may be combined with any one or more of the embodiments shown above in FIGS. 1 to 6. The method may include the following steps S701 to S703.

At S701, a refresh token is sent to the resource requester.

In an optional embodiment of the present disclosure, the first entity, the resource requester, and the UE may collaborate to perform the UE unreachability information configuration authorization, e.g., perform the UE unreachability information configuration authorization under the OAuth 2.0 standard framework. In an optional embodiment, the first entity may first send the refresh token to the resource requester.

At S702, an access token request sent by the resource requester is received, where the access token request includes the refresh token, and the access token request is used for requesting the access token.

In an optional embodiment of the present disclosure, the first entity may receive the access token request sent by the resource requester, where the request may include the refresh token, and the request is used for the resource requester to request the access token from the first entity.

At S703, the access token is sent to the resource requester in response to the access token request.

In an optional embodiment of the present disclosure, the first entity may, in response to the access token request, send the access token to the resource requester, where the access token includes the UE unreachability period information.

In other words, the embodiment may be skipped if the CCF/authorization function sends the access token to the AF. In an optional implementation shown in this embodiment, the resource requester AF may send the refresh token to the first entity CCF/authorization function to request the access token. The CCF/authorization function may send the access token to the AF.

In an optional embodiment, instead of sending the access token directly to the resource requester, the first entity may first send the refresh token, where the refresh token is used for the resource requester to request the access token. In this case, protecting the security of the access token or improving the authorization efficiency can be achieved, avoiding the first entity to repeat the authorization process to issue the access token. For example, the first entity sends the refresh token to the resource requester, and the refresh token serves to enable the resource requester to request a new access token from the first entity after the access token has expired without the need for repeated authorization processes, thereby avoiding the first entity from repeatedly issuing the access token.

In summary, according to the information configuration method provided in the present disclosure, the first entity can send the refresh token to the resource requester and receive the access token request sent by the resource requester, where the access token request is used for requesting the access token; and the first entity can send the access token to the resource requester in response to the access token request. The schemes provided in the present disclosure achieve that the core network is allowed to authorize the resource requester to configure the UE unreachability information.

FIG. 8 shows a schematic flow diagram of an information configuration method according to an embodiment of the present disclosure. The method may be performed by a resource requester. As described above, the resource requester may be an AF. As shown in FIG. 8, the method may include the following step S801.

At 801, the resource requester obtains an access token by performing UE unreachability information configuration authorization through collaborating with a first entity and a UE.

In some embodiments, the access token includes UE unreachability period information. In an optional embodiment, the UE unreachability period information included in the access token is used for indicating that a resource allowed by the token for operation by the resource requester is the UE unreachability period information.

It should be understood that the access token at least includes an identification of the UE, and the UE unreachability period information. The access token may further include other information, which is not limited in this embodiment.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

In an optional embodiment of the present disclosure, the manner in which the resource requester performs the UE unreachability information configuration authorization through collaborating with the first entity and the UE is not limited in the present disclosure. In an optional embodiment, the resource requester may perform, based on an OAuth 2.0 standard framework or another framework, the UE unreachability information configuration authorization through collaborating with the first entity and the UE, which is not limited in the present disclosure.

In an optional embodiment of the present disclosure, the first entity may be a CCF or an authorization function.

In summary, according to the information configuration method provided in the present disclosure, the resource requester can perform the UE unreachability information configuration authorization through collaborating with the first entity and the UE, thereby sending the access token to the resource requester, where the access token includes the UE unreachability period information. The schemes provided in the present disclosure achieve that the core network is allowed to authorize the resource requester to configure the UE unreachability information.

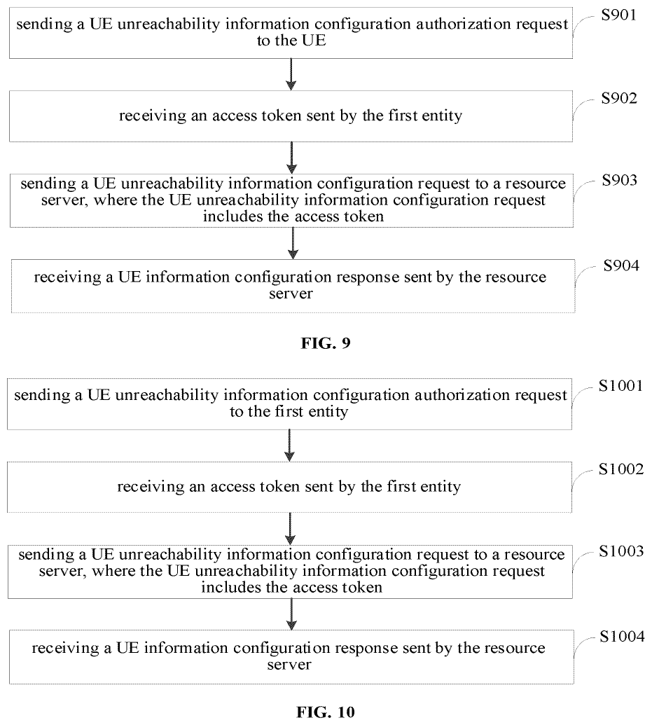

In some optional embodiments of the present disclosure, taking the OAuth 2.0 standard framework as an example, there are two authorization mechanisms, which are collectively referred to in the present disclosure as that the resource requester, the first entity, and the UE collaborate based on the OAuth 2.0 standard framework to perform the UE unreachability information configuration authorization. Upon authorization, the first entity is capable of sending the access token to the resource requester, thereby authorizing the resource requester to configure the UE unreachability information. Corresponding to FIGS. 2, 3, 5, and 6, and based on the embodiment shown in FIG. 8, the following respectively describes, through FIGS. 9 and 10, the two authorization mechanisms under the OAuth 2.0 standard framework proposed in the present disclosure.

FIG. 9 shows a schematic flow diagram of an information configuration method according to an embodiment of the present disclosure. The method may be performed by the resource requester. Based on the embodiment shown in FIG. 8, the embodiment shown in FIG. 9 illustrates a first authorization mechanism in which the resource requester sends a request to the UE. Specifically, the method may include the following steps S901 to S904.

At S901, a UE unreachability information configuration authorization request is sent to the UE.

In an optional embodiment of the present disclosure, the UE unreachability information configuration authorization request may include at least one of the following: an identification of the resource requester, an identification of the UE, an identification of a requested service, the UE unreachability period information, and an identification of a service operation requested to act on the UE unreachability period information.

In an optional embodiment, the UE unreachability period information included in the UE unreachability information configuration authorization request is used for indicating that the resource requested by the resource requester for configuration is the UE unreachability period information. In some optional embodiments, the UE has other information such as QoS information, UE related 5GC assistance information, etc. that may be requested by the AF for exposure or configuration, which is not limited in the present disclosure.

In an optional embodiment of the present disclosure, the service identification may include Nnef_ParameterProvision.

In an optional embodiment of the present disclosure, the identification of the service operation may include at least one of the following: Nnef_ParameterProvision_Update service operation, Nnef_ParameterProvision_Create service operation, Nnef ParameterProvision Delete service operation, Nnef_ParameterProvision_Get service operation.

In some specific embodiments, the UE unreachability information configuration authorization request may include different contents in different cases.

1) In a case where the resource requester has obtained the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), and the UE unreachability period information.

2) In a case the resource requester does not obtain the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), the identification of the requested service (e.g., Nnef_ParameterProvision), the identification of the service operation requested to act on the UE unreachability period information (e.g., Nnef_ParameterProvision_Update service operation, Nnef_ParameterProvision_Create service operation, Nnef ParameterProvision_Delete service operation, Nnef ParameterProvision_Get service operation), and the UE unreachability period information.

In an optional embodiment of the present disclosure, the UE unreachability period information included in the UE unreachability information configuration authorization request is used for indicating that the resource requested by the resource requester for configuration is the UE unreachability period information.

In an optional embodiment of the present disclosure, the identification of the requested service may include at least one of the following: a service name identifier (Service Name), a service operation identifier (Service Operation), an operation semantics identifier (Operation Semantics), an API identifier.

In an optional embodiment of the present disclosure, before the resource requester AF sends the request to the UE, the AF and the UE need to authenticate each other, which is not described herein.

At S902, the access token sent by the first entity is received.

In an optional embodiment of the present disclosure, the resource requester AF may send the UE unreachability information configuration authorization request to the UE, and the UE may perform real-time authorization on the request by using an authorization code grant type. In response to the real-time authorization by the UE, the first entity may send the access token to the resource requester AF.

In an optional embodiment of the present disclosure, before the resource requester AF sends the request to the UE, the AF and the UE need to authenticate each other, which is not described herein.

In an optional embodiment of the present disclosure, when the AF sends the authorization request to the UE, the AF, the UE, and the CCF/authorization function need to perform the UE unreachability information configuration authorization based on the OAuth 2.0. Optionally, this embodiment uses the authorization code grant type, where the UE can authorize the request in a timely and real-time manner to trigger the first entity to send the access token to the resource requester, and the access token includes the UE unreachability period information. In this case, the UE, the AF, and the CCF/authorization function serve as the resource owner, the client, and the authorization server respectively.

In an optional embodiment of the present disclosure, the access token may include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

At S903, a UE unreachability information configuration request is sent to a resource server, where the UE unreachability information configuration request includes the access token.

In an optional embodiment of the present disclosure, the resource server may be an NEF or an AEF.

Optionally, the resource requester AF sends the UE unreachability information configuration request to the resource server NEF/AEF, where the request may include the access token received from the first entity, enabling the NEF/AEF to determine, based on the token, whether to authorize the AF to perform the configuration of the UE unreachability period information.

At S904, a UE information configuration response sent by the resource server is received.

In the present disclosure, receiving the UE information configuration response sent by the resource server may be: obtaining an authorization response of the resource server to the UE unreachability information configuration request; or obtaining a rejection response of the resource server to the UE unreachability information configuration request and a reason for rejection.

Optionally, the NEF/AEF may authorize the request based on the access token, i.e., authorize the AF to perform the configuration of the UE information. If the AF is not authorized, i.e., the request will be rejected by the NEF/AEF, then the NEF/AEF will terminate the procedure, and it is required for the NEF/AEF to indicate to the AF the reason for the failure.

In summary, according to the information configuration method provided in the present disclosure, for the authorization mechanism in which the resource requester sends the UE unreachability information configuration authorization request to the UE, the resource requester can receive the access token sent by the first entity, where the access token includes the UE unreachability period information. The schemes provided in the present disclosure achieve that the core network is allowed to authorize the resource requester to configure the UE unreachability information.

FIG. 10 shows a schematic flow diagram of an information configuration method according to an embodiment of the present disclosure. The method may be performed by the resource requester. Based on the embodiment shown in FIG. 8, the embodiment shown in FIG. 10 illustrates a second authorization mechanism in which the resource requester sends a request to the first entity, and the UE participates in it. Specifically, the method may include the following steps S1001 to S1004.

At S1001, a UE unreachability information configuration authorization request is sent to the first entity.

In an optional embodiment of the present disclosure, the resource requester AF may send the UE unreachability information configuration authorization request to the first entity CCF/authorization function.

Under this authorization mechanism, the UE needs to send the authorization information to the first entity CCF/authorization function. The authorization information is used for determining whether the resource requester is capable of configuring the UE unreachability period information for the UE. The authorization information may include at least one of the following: an identification of the resource requester, an identification of the UE, an identification of an allowed service, the UE unreachability period information, an expiration time, and an identification of a service operation allowed to act on the UE unreachability period information.

In an optional embodiment of the present disclosure, the UE unreachability period information included in the authorization information is used for indicating that the resource allowed by the authorization information for operation by the resource requester is the UE unreachability period information.

In some optional embodiments, the UE has other information such as QoS information, UE related 5GC assistance information, etc. that may be requested by the AF for exposure or configuration, which is not limited in the present disclosure.

In an optional embodiment of the present disclosure, before the request is sent, the first entity CCF/authorization function and the resource requester AF need to authenticate each other, which is not described herein.

At S1002, the access token sent by the first entity is received.

In an optional embodiment of the present disclosure, when the AF sends the authorization request to the CCF/authorization function, the AF and the CCF/authorization function need to perform the UE unreachability information configuration authorization based on the OAuth 2.0. Optionally, this embodiment uses the client credentials grant type to cause the first entity to send the access token to the resource requester, where the access token includes the UE unreachability period information. The AF and the CCF/authorization function serve as the client and the authorization server respectively.

In an optional embodiment of the present disclosure, the access token may further include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a GPSI, an IMSI, an application layer ID, etc., which is not limited in the present disclosure.

In an optional embodiment of the present disclosure, the UE unreachability period information may include at least one of the following: information about a maximum latency, information about a maximum response, information about time when the UE is provided with signal coverage, and information about time when the UE is out of signal coverage. In some embodiments, the information about time when the UE is provided with signal coverage refers to information related to when the UE is expected to be provided with signal coverage, and the information about time when the UE is out of signal coverage refers to information related to when the UE is expected to be out of signal coverage.

At S1003, a UE unreachability information configuration request is sent to a resource server, where the UE unreachability information configuration request includes the access token.

In an optional embodiment of the present disclosure, the resource server may be an NEF/AEF.

Optionally, the resource requester AF sends the UE unreachability information configuration request to the resource server NEF/AEF, where the request may include the access token received from the first entity, enabling the NEF/AEF to determine, based on the token, whether to authorize the AF to perform the configuration of the UE information.

At S1004, a UE information configuration response sent by the resource server is received.

In the present disclosure, receiving the UE information configuration response sent by the resource server may be: obtaining an authorization response of the resource server to the UE unreachability information configuration request; or obtaining a rejection response of the resource server to the UE unreachability information configuration request and a reason for rejection.

Optionally, the NEF/AEF may authorize the request based on the access token, i.e., authorize the AF to perform the configuration of the UE information. If the AF is not authorized, i.e., the request will be rejected by the NEF/AEF, then the NEF/AEF will terminate the procedure, and it is required for the NEF/AEF to indicate to the AF the reason for the failure.

In summary, according to the information configuration method provided in the present disclosure, for the authorization mechanism in which the resource requester sends the authorization request to the first entity, the resource requester can receive the access token sent by the first entity, where the access token includes the UE unreachability period information. The schemes provided in the present disclosure achieve that the core network is allowed to authorize the resource requester to configure the UE unreachability information.

As an optional embodiment, FIG. 11 shows a schematic flow diagram of an information configuration method according to an embodiment of the present disclosure. The method may be performed by the resource requester. Based on the embodiment shown in FIG. 8, the embodiment shown in FIG. 11 may be combined with any one or more of the embodiments shown above in FIGS. 1 to 10. The method may include the following steps S1101 to S1103.

At S1101, a refresh token sent by the first entity is received.

In an optional embodiment of the present disclosure, the first entity, the resource requester, and the UE may collaborate to perform the UE unreachability information configuration authorization, e.g., perform the UE unreachability information configuration authorization under the OAuth 2.0 standard framework. The first entity may first send the refresh token to the resource requester.

At S1102, an access token request is sent to the first entity, where the access token request includes the refresh token, and the access token request is used for requesting the access token.

In an optional embodiment of the present disclosure, the resource requester may send the access token request to the first entity, where the request is used for the resource requester to request the access token from the first entity.

At S1103, the access token sent by the first entity is received.

In an optional embodiment of the present disclosure, the first entity may, in response to the access token request, send the access token to the resource requester, where the access token includes the UE unreachability period information.

In other words, the embodiment may be skipped if the CCF/authorization function sends the access token to the AF. In an optional implementation shown in this embodiment, the resource requester AF may send the refresh token to the first entity CCF/authorization function to request the access token. The CCF/authorization function may send the access token to the AF.

In an optional embodiment, instead of sending the access token directly to the resource requester, the first entity may first send the refresh token, where the refresh token is used for the resource requester to request the access token. In this case, protecting the security of the access token or improving the authorization efficiency can be achieved, avoiding the first entity to repeat the authorization process to issue the access token. For example, the first entity sends the refresh token to the resource requester, and the refresh token serves to enable the resource requester to request a new access token from the first entity after the access token has expired without the need for repeated authorization processes, thereby avoiding the first entity from repeatedly issuing the access token.

In summary, according to the information configuration method provided in the present disclosure, the resource requester can receive the refresh token sent by the first entity, and send the access token request to the first entity for requesting the access token, thereby receiving the access token sent by the first entity in response to the access token request, where the access token includes the UE unreachability period information. The schemes provided in the present disclosure achieve that the core network is allowed to authorize the resource requester to configure the UE unreachability information.

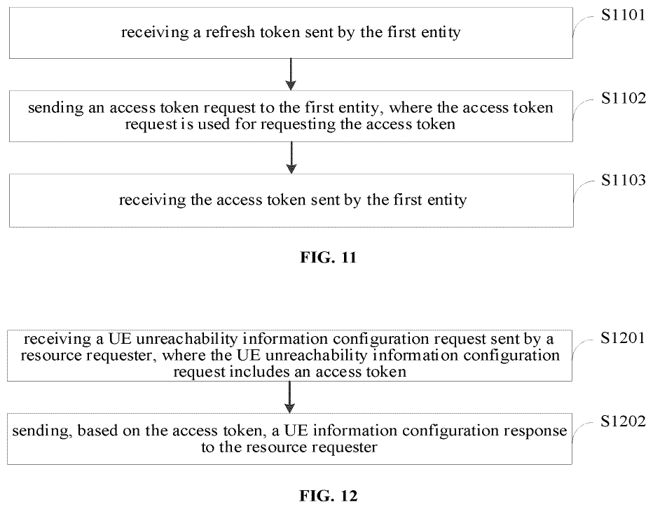

FIG. 12 shows a schematic flow diagram of an information configuration method according to an embodiment of the present disclosure. The method may be performed by a resource server. As described above, the resource server may be an NEF/AEF. As shown in FIG. 12, the method may include the following steps S1201 to S1202.

At S1201, a UE unreachability information configuration request sent by a resource requester is received, where the UE unreachability information configuration request includes an access token.

In an optional embodiment of the present disclosure, the resource requester may be an AF. Based on the embodiment described above in FIGS. 1 to 11, the resource requester may perform the UE unreachability information configuration authorization through collaborating with the UE and the first entity, and the resource requester may obtain the access token from the first entity, and the access token includes the UE unreachability period information. In the case where the resource requester has obtained the access token from the first entity, the resource requester may send the access token to the resource server, for example, by sending to the resource server the UE unreachability information configuration request carrying the access token, thereby requesting the resource server to authorize the resource requester to perform the configuration of the UE information. Accordingly, the resource server may receive the access token sent by the resource requester to determine whether to authorize the resource requester.

In an optional embodiment of the present disclosure, the access token may include at least one of the following: an identification of the UE, an identification of the first entity (e.g., NFInstance ID, NF ID), an identification of the resource requester (e.g., AF_ID, NAF ID, FQDN, IP address, GPSI, IMSI, application layer ID), an identification of an NEF (e.g., NFInstance ID, NF ID), an identification of an AEF (e.g., NFInstance ID, NF ID), a service identification (optional), an identification of the UE, the UE unreachability period information, an identification of a service operation allowed to act on the UE unreachability period information, and an expiration time.

In an optional embodiment of the present disclosure, the UE unreachability period information included in the access token is used for indicating that the resource allowed by the token for operation by the resource requester is the UE unreachability period information.

In an optional embodiment of the present disclosure, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

At S1202, a UE information configuration response is sent, based on the access token, to the resource requester.

In an optional embodiment of the present disclosure, the resource server may determine, based on the access token sent by the resource requester, whether to authorize the resource requester to perform the configuration of the UE information.

Specifically, in an optional embodiment, the resource server may send to the resource requester an authorization response to the UE unreachability information configuration request. For example, the NEF/AEF may authorize the AF based on the access token, i.e., authorize the AF to perform the configuration of the UE information.

In another optional embodiment, the resource server may send to the resource requester a rejection response to the UE unreachability information configuration request and a reason for the rejection. For example, if the NEF/AEF rejects to authorize the AF to perform the configuration of the UE information, i.e., rejects the UE unreachability information configuration request sent by the resource requester, the NEF/AEF will terminate the procedure, and it is required for the NEF/AEF to indicate to the AF the reason for the failure.

In an optional embodiment of the present disclosure, the resource requester AF may send to the resource server NEF/AEF an identification of the AF, an identification of the target UE, the UE unreachability period data, and the token. The resource server NEF/AEF may compare whether the sent data matches with the content of the token, i.e., determine whether the AF has authorization to configure the UE unreachability period information for the target UE. In a case where it is determined that the AF has the authorization to configure the UE unreachability period information for the target UE, the resource server NEF/AEF sends the UE unreachability period information sent by the resource requester AF to the unified data management (UDM)/unified data repository (UDR), and the UDM/UDR sends the UE unreachability period information to the AMF; in a case where it is determined that the AF is not authorized to configure the UE unreachability period information for the target UE, the resource server NEF/AEF sends the rejection response.

In summary, according to the information configuration method provided in the present disclosure, the resource server can receive the UE unreachability information configuration request sent by the resource requester, where the UE unreachability information configuration information may include the access token, the access token includes the UE unreachability period information, and the resource server sends the UE information configuration response to the resource server based on the access token. The schemes provided in the present disclosure achieve that the core network is allowed to authorize the resource requester to configure the UE unreachability information.

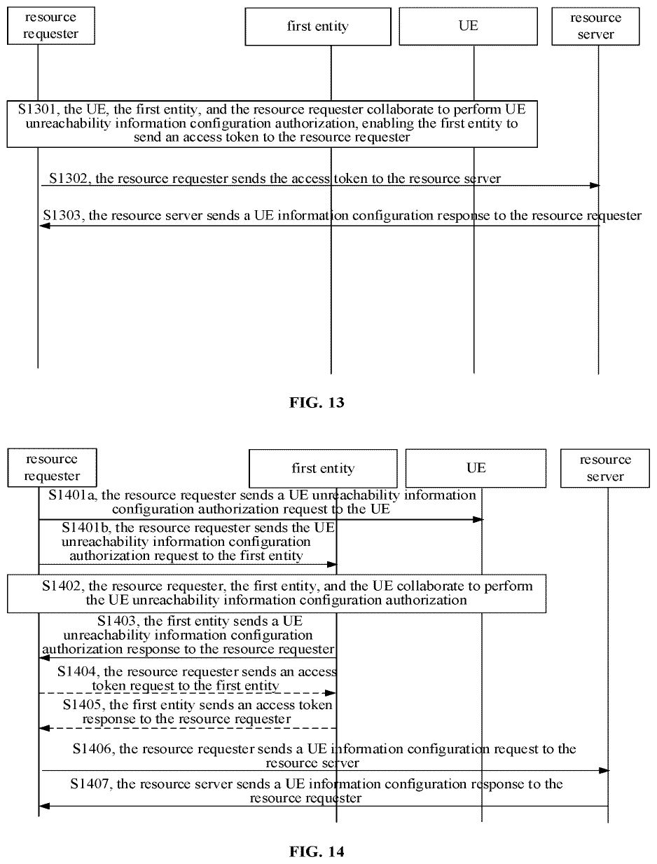

FIG. 13 shows a schematic interaction diagram of an information configuration method according to an embodiment of the present disclosure. The method may be performed by a communication system. The communication system at least includes a UE, a first entity, a resource requester, and a resource server. As shown in FIG. 13, the method may include the following steps S1301 to S1303.

At S1301, the UE, the first entity, and the resource requester collaborate to perform UE unreachability information configuration authorization, enabling the first entity to send an access token to the resource requester.

In some embodiments, the access token includes UE unreachability period information.

At S1302, the resource requester sends the access token to the resource server.

At S1303, the resource server sends a UE information configuration response to the resource requester.

The principle of the above steps is the same as that of the embodiments shown in FIGS. 1 to 12, and will not be repeated herein.

In summary, according to the information configuration method provided in the present disclosure, the UE, the first entity, and the resource requester collaborate to perform the UE unreachability information configuration authorization, enabling the first entity to send the access token to the resource requester, and the resource requester sends the access token to the resource server and receives the UE information configuration response sent by the resource server, where the access token includes the UE unreachability period information. The schemes provided in the present disclosure achieve that the core network is allowed to authorize the resource requester to configure the UE unreachability information.

As a specific implementation of the embodiment shown in FIG. 13, FIG. 14 shows a schematic interaction diagram of an information configuration method according to an embodiment of the present disclosure. The method may be performed by the communication system. The communication system may include the UE, the first entity, the resource requester, and the resource server. In some embodiments, the first entity may be a CCF or an authorization function, the resource requester may be an AF, and the resource server may be an NEF or an AEF. As shown in FIG. 14, the method may include the following steps S1401a to S1407.

At S1401a, the resource requester sends a UE unreachability information configuration authorization request to the UE.

In an optional embodiment of the present disclosure, the AF sends the UE unreachability information providing configuration request to the UE.

In an optional embodiment, before the request is sent, the AF and the UE need to authenticate each other.

The UE unreachability information configuration authorization request may include at least one of the following: an identification of the resource requester, an identification of the UE, an identification of a requested service, the UE unreachability period information, and an identification of a service operation requested to act on the UE unreachability period information. In an optional embodiment of the present disclosure, the UE unreachability period information included in the UE unreachability information configuration authorization request is used for indicating that the resource requested by the resource requester for configuration is the UE unreachability period information. In some optional embodiments, the UE has other information such as QoS information, UE related 5GC assistance information, etc. that may be requested by the AF for exposure or configuration, which is not limited in the present disclosure.

In some specific embodiments, the UE unreachability information configuration authorization request may include different contents in different cases.

1) In a case where the resource requester has obtained the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), and the UE unreachability period information.

2) In a case the resource requester does not obtain the authorization for the service and the service operation, the UE unreachability information configuration authorization request may include at least one of the following: the identification of the resource requester (e.g., AF_ID, NAF ID, FQDN, IP address, GPSI, IMPI, or application layer ID), the identification of the UE (e.g., GPSI, IMPI, or application layer ID), the identification of the requested service (e.g., Nnef_ParameterProvision), the identification of the service operation requested to act on the UE unreachability period information (e.g., Nnef_ParameterProvision_Update service operation, Nnef_ParameterProvision_Create service operation, Nnef ParameterProvision_Delete service operation, Nnef_ParameterProvision_Get service operation), and the UE unreachability period information.

In an optional embodiment of the present disclosure, the identification of the requested service may include at least one of the following: a service name identifier (Service Name), a service operation identifier (Service Operation), an operation semantics identifier (Operation Semantics), an API identifier.

At 1401b, the resource requester sends the UE unreachability information configuration authorization request to the first entity.

In an optional embodiment of the present disclosure, the AF sends the UE unreachability information configuration authorization request to the CCF/authorization function.

In an optional embodiment, before the request is sent, the CCF/authorization function and the AF need to authenticate each other.

At 1402, the resource requester, the first entity, and the UE collaborate to perform the UE unreachability information configuration authorization.

In an optional embodiment of the present disclosure, in an authorization mechanism in which the AF sends the authorization request to the UE, the AF, the UE, and the CCF/authorization function need to perform the UE unreachability information configuration authorization, for example, perform the UE unreachability information configuration authorization based on the OAuth 2.0 standard framework. Optionally, this embodiment may use the authorization code grant type, where the UE can authorize the request in a timely and real-time manner. The UE, the AF, and the CCF/authorization function serve as the resource owner, the client, and the authorization server respectively.

In an authorization mechanism in which the AF sends the authorization request to the CCF/authorization function, the AF and the CCF/authorization function need to perform the UE unreachability information configuration authorization, for example, perform the UE unreachability information configuration authorization based on the OAuth 2.0 standard framework. Optionally, this embodiment uses the client credentials grant type. The AF and the CCF/authorization function serve as the client and the authorization server respectively. Under this authorization mechanism, the UE needs to send the authorization information to the CCF/authorization function. The authorization information determines whether a specific AF is capable of providing specific information. The authorization information may include at least one of the following: an identification of the AF (e.g., AF_ID, application layer ID, FQDN), an identification of the UE (e.g., SUPI, SUCI, IMPI, terminal application layer ID, GPSI), the UE unreachability period information, an expiration time (or expiration), and an authorization policy (e.g., a specific AF is capable of providing the UE unreachability period information). In an optional embodiment of the present disclosure, the UE unreachability period information included in the authorization information is used for indicating that the resource allowed by the authorization information for operation by the resource requester is the UE unreachability period information. In some optional embodiments, the UE has other information such as QoS information, UE related 5GC assistance information, etc. that may be requested by the AF for exposure or configuration, which is not limited in the present disclosure.

At S1403, the first entity sends a UE unreachability information configuration authorization response to the resource requester.

In an optional embodiment of the present disclosure, the CCF/authorization function may send the UE unreachability information configuration authorization response to the AF, i.e., send a refresh token/access token. The access token includes the UE unreachability period information. The access token may further include an identification of the UE, an identification of the CCF (e.g., NF instance ID, NF ID), an identification of an authorization function (e.g., NF instance ID, NF ID), an identification of an NEF (e.g., NF instance ID, NF ID), an identification of an AEF (e.g., NF instance ID, NF ID), an identification of a requested service (optional), an identification of a service operation allowed to act on the UE unreachability period information (optional), an identification of an AF (e.g., GPSI, IMSI, application layer ID), and an expiration time.

In an optional embodiment of the present disclosure, the identification of the UE may be any one of the information used for identifying the UE identity, such as a GPSI, an IMSI, an application layer ID, etc., which is not limited in the present disclosure. When the access token includes the identification of the UE, allowing the core network to authorize the resource requester to configure the UE unreachability information related to a specific UE can be achieved.

At S1404, the resource requester sends an access token request to the first entity.

In an optional embodiment of the present disclosure, steps S1404, S1405 may be skipped if the CCF/authorization function sends the access token to the AF in step S1403. The access token request sent by the AF to the CCF/authorization function may include the refresh token for requesting the access token.

At S1405, the first entity sends an access token response to the resource requester.

In an optional embodiment of the present disclosure, based on step S1404, the CCF/authorization function may send the access token to the AF.

In an optional embodiment, instead of sending the access token directly to the resource requester AF, the first entity CCF/authorization function may first send the refresh token, where the refresh token is used for the resource requester AF to request the access token. In this case, protecting the security of the access token or improving the authorization efficiency can be achieved, avoiding the first entity CCF/authorization function to repeat the authorization process to issue the access token. For example, the first entity CCF/authorization function sends the refresh token to the resource requester AF, and the refresh token serves to enable the resource requester AF to request a new access token from the first entity CCF/authorization function after the access token has expired without the need for repeated authorization processes, thereby avoiding the first entity from repeatedly issuing the access token.

At S1406, the resource requester sends a UE information configuration request to the resource server.

In an optional embodiment of the present disclosure, the AF sends a UE unreachability information configuration request to the NEF/AEF, where the request may include the access token. The NEF/AEF plays the role of the resource server in the OAuth 2.0, enabling the NEF/AEF to determine, based on the token, whether to authorize the AF to perform the configuration of the UE information.

At S1407, the resource server sends a UE information configuration response to the resource requester.

In an optional embodiment of the present disclosure, the UE information configuration response may specifically be an authorization response or a rejection response of the resource server to the UE unreachability information configuration request. Optionally, the NEF/AEF may authorize the request based on the access token, i.e., authorize the AF to perform the configuration of the UE information. If the AF is not authorized, i.e., the request will be rejected by the NEF/AEF, then the NEF/AEF will terminate the procedure, and it is required for the NEF/AEF to indicate to the AF the reason for the failure.

In an optional embodiment, the resource requester AF may send to the resource server NEF/AEF an identification of the AF, an identification of the target UE, the UE unreachability period data, and the token. The resource server NEF/AEF may compare whether the sent data matches with the content of the token, i.e., determine whether the AF has authorization to configure the UE unreachability period information for the target UE. In a case where it is determined that the AF has the authorization to configure the UE unreachability period information for the target UE, the resource server NEF/AEF sends the UE unreachability period information sent by the resource requester AF to the UDM/UDR, and the UDM/UDR sends the UE unreachability period information to the AMF; in a case where it is determined that the AF is not authorized to configure the UE unreachability period information for the target UE, the resource server NEF/AEF sends the rejection response.

The principle of the above steps is the same as that of the embodiments shown in FIGS. 1 to 13, and will not be repeated herein.

It should be understood that one of the above steps S1401a and S1401b is performed selectively. Steps S1404 and S1405 are optional steps. In a case the CCF/authorization function sends the access token to the AF, steps S1404 and S1405 are not performed. In a case where the CCF/authorization function sends the refresh token to the AF, steps S1404 and S1405 are performed.

In summary, according to the information configuration method provided in the present disclosure, the UE, the first entity, and the resource requester collaborate to perform the UE unreachability information configuration authorization, enabling the first entity to send the access token to the resource requester, and the resource requester sends the access token to the resource server and receives the UE information configuration response sent by the resource server, where the access token includes the UE unreachability period information. The schemes provided in the present disclosure achieve that the core network is allowed to authorize the resource requester to configure the UE unreachability information.

It should be understood that the above embodiments may be implemented in any combination or individually, which is not limited in the present disclosure.

In the above embodiments provided in the present application, the methods provided by the embodiments of the present application are introduced from the perspectives of the UE, the first entity, the resource requester, and the resource server respectively. In order to achieve the functions of the methods provided in the embodiments of the present application, the UE, the first entity, the resource requester, and the resource server may include hardware structures and software modules, and achieve the functions described above by means of hardware structures, software modules or hardware structure plus software modules. A certain one of the above functions may be executed in the form of hardware structure, software module, or hardware structure plus software module.

Corresponding to the information configuration method provided in the above-described several embodiments, the present disclosure further provides an information configuration apparatus. Since the information configuration apparatus provided in the embodiments of the present disclosure corresponds to the information configuration method provided in the above-described several embodiments, the embodiments of the information configuration method are also applicable to the information configuration apparatus provided in this embodiment, which will not be described in detail in this embodiment.

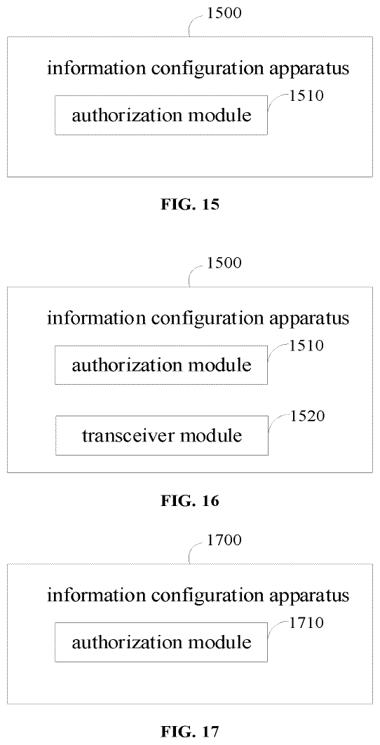

FIG. 15 is a schematic structure diagram of an information configuration apparatus 1500 provided in an embodiment of the present disclosure. The information configuration apparatus 1500 is configured in a UE.

As shown in FIG. 15, the apparatus 1500 includes an authorization module 1510. The authorization module 1510 is configured to trigger, by performing UE unreachability information configuration authorization through collaborating with a first entity and a resource requester, the first entity to send an access token to the resource requester, where the access token includes UE unreachability period information.

According to the information configuration apparatus provided in the present disclosure, the UE, the first entity and the resource requester collaborate to perform the UE unreachability information configuration authorization, thereby triggering the first entity to send the access token to the resource requester, where the access token includes the UE unreachability period information. The schemes provided in the present disclosure achieve that the core network is allowed to authorize the resource requester to configure the UE unreachability information.

In an optional embodiment of the present disclosure, the authorization module 1510 is configured to perform, based on an OAuth 2.0 standard framework, the UE unreachability information configuration authorization through collaborating with the first entity and the resource requester.

In an optional embodiment of the present disclosure, the access token includes at least one of the following: an identification of the UE, an identification of the first entity, an identification of the resource requester, an identification of an NEF, an identification of an AEF, a service identification, an identification of a service operation allowed to act on the UE unreachability period information, and an expiration time.

In an optional embodiment of the present disclosure, as shown in FIG. 16, the apparatus 1500 further includes a transceiver module 1520 that is configured to receive a UE unreachability information configuration authorization request sent by the resource requester, where the UE unreachability information configuration authorization request includes at least one of the following: an identification of the resource requester, an identification of the UE, an identification of a requested service, the UE unreachability period information, and an identification of a service operation requested to act on the UE unreachability period information.

In an optional embodiment of the present disclosure, the authorization module 1510 is further configured to perform, by using an authorization code grant type, real-time authorization on the UE unreachability information configuration authorization request.

In an optional embodiment of the present disclosure, the transceiver module 1520 is further configured to send authorization information to the first entity, where the authorization information is used for determining whether the resource requester is capable of configuring the UE unreachability period information for the UE, and the authorization information includes at least one of the following: an identification of the resource requester, an identification of the UE, an identification of an allowed service, the UE unreachability period information, an expiration time, and an identification of a service operation allowed to act on the UE unreachability period information.

In an optional embodiment of the present disclosure, the authorization module 1510 is further configured to perform, by using a client credentials grant type, authorization on a UE unreachability information configuration authorization request.

In an optional embodiment of the present disclosure, the UE unreachability period information may include at least one of the following: information about a maximum latency, information about a maximum response, information about time when the UE is provided with signal coverage, and information about time when the UE is out of signal coverage.

In summary, for the authorization mechanism in which the UE receives the UE unreachability information configuration authorization request sent by the resource requester, the UE can perform, by using the authorization code grant type, the real-time authorization on the UE unreachability information configuration authorization request, thereby triggering the first entity to send the access token to the resource requester. Under the authorization mechanism in which the resource requester sends the authorization request to the first entity, the UE can send the authorization information to the first entity, thereby triggering the first entity to send the access token to the resource requester. The schemes provided in the present disclosure achieve that the core network is allowed to authorize the resource requester to configure the UE unreachability information.

FIG. 17 is a schematic structure diagram of an information configuration apparatus 1700 provided in an embodiment of the present disclosure. The information configuration apparatus 1700 is configured in a first entity.

As shown in FIG. 17, the apparatus 1700 includes an authorization module 1710. The authorization module 1710 is configured to trigger, by performing UE unreachability information configuration authorization through collaborating with a first entity and a resource requester, the first entity to send an access token to the resource requester, where the access token includes UE unreachability period information.

According to the information configuration apparatus provided in the present disclosure, the first entity may perform the UE unreachability information configuration authorization through collaborating with the resource requester and the UE, thereby sending the access token to the resource requester, where the access token includes the UE unreachability period information. The schemes provided in the present disclosure achieve that the core network is allowed to authorize the resource requester to configure the UE unreachability information.

In an optional embodiment of the present disclosure, the authorization module 1710 may be configured to perform, based on an OAuth 2.0 standard framework, the UE unreachability information configuration authorization through collaborating with the resource requester and the UE.

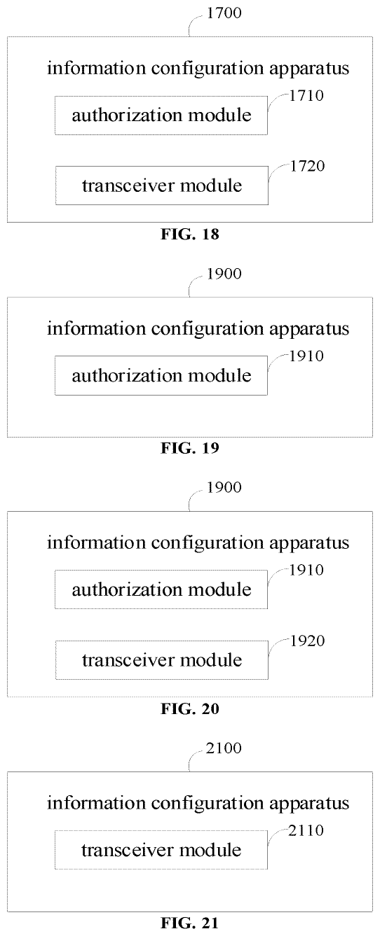

In an optional embodiment of the present disclosure, as shown in FIG. 18, the apparatus 1700 further includes a transceiver module 1720. The transceiver module 1720 is configured to send, based on an authorization code grant type, the access token to the resource requester.

In an optional embodiment of the present disclosure, the transceiver module 1720 is further configured to receive authorization information sent by the UE, and receive a UE unreachability information configuration authorization request sent by the resource requester. The authorization module 1710 is further configured to send the access token to the resource requester through performing based on the authorization information, by using a client credentials grant type, authorization on the UE unreachability information configuration authorization request. The authorization information is used for determining whether the resource requester is capable of configuring the UE unreachability information for the UE. The authorization information may include at least one of the following: an identification of the resource requester, an identification of the UE, an identification of an allowed service, the UE unreachability period information, an identification of a service operation allowed to act on the UE unreachability period information, and an expiration time.

In an optional embodiment of the present disclosure, the transceiver module 1720 is further configured to send a refresh token to the resource requester; receive an access token request sent by the resource requester, where the access token request is used for requesting the access token; and send, in response to the access token request, the access token to the resource requester.

In an optional embodiment of the present disclosure, the access token may include at least one of the following: an identification of the UE, an identification of the first entity, an identification of the resource requester, an identification of an NEF, an identification of an AEF, a service identification, an identification of a service operation allowed to act on the UE unreachability period information, and an expiration time.

According to the information configuration apparatus provided in the present disclosure, for the authorization mechanism in which the resource requester sends the UE unreachability information configuration authorization request to the UE, the first entity can send the access token to the resource requester based on the authorization code grant type, thereby sending the access token to the resource requester. Under the authorization mechanism in which the resource requester sends the authorization request to the first entity, the first entity can receive the UE unreachability information configuration authorization request sent by the resource requester, and the authorization information sent by the UE, causing the first entity, based on the authorization information, to perform the authorization on the UE unreachability information configuration authorization request by using the client credentials grant type, thereby sending the access token to the resource requester. In addition, the first entity can send the refresh token to the resource requester, and receive the access token request sent by the resource requester, where the access token request is used for requesting the access token; and the first entity can send, in response to the access token request, the access token to the resource requester. The schemes provided in the present disclosure achieve that the core network is allowed to authorize the resource requester to configure the UE unreachability information.

FIG. 19 is a schematic structure diagram of an information configuration apparatus 1900 provided in an embodiment of the present disclosure. The information configuration apparatus 1900 is configured in a resource requester.

As shown in FIG. 19, the apparatus 1900 includes an authorization module 1910. The authorization module 1910 is configured to obtain an access token by performing UE unreachability information configuration authorization through collaborating with a first entity and a UE, where the access token includes UE unreachability period information.

According to the information configuration apparatus provided in the present disclosure, the resource requester may perform the UE unreachability information configuration authorization through collaborating with the first entity and the UE, thereby sending the access token to the resource requester, where the access token includes the UE unreachability period information. The schemes provided in the present disclosure achieve that the core network is allowed to authorize the resource requester to configure the UE unreachability information.

In an optional embodiment of the present disclosure, the authorization module 1910 may be configured to perform, based on an OAuth 2.0 standard framework, the UE unreachability information configuration authorization through collaborating with the first entity and the UE.

In an optional embodiment of the present disclosure, as shown in FIG. 20, the apparatus 1900 further includes a transceiver module 1920. The transceiver module 1920 is configured to send a UE unreachability information configuration authorization request to the UE, where the UE unreachability information configuration authorization request may include at least one of the following: an identification of the resource requester, an identification of the UE, an identification of a requested service, the UE unreachability period information, and an identification of a service operation requested to act on the UE unreachability period information.

In an optional embodiment of the present disclosure, the transceiver module 1920 is further configured to send a UE unreachability information configuration authorization request to the first entity.

In an optional embodiment of the present disclosure, the transceiver module 1920 is further configured to: send a UE unreachability information configuration request to a resource server, where the UE unreachability information configuration request includes the access token; and receive a UE information configuration response sent by the resource server.

In an optional embodiment of the present disclosure, the transceiver module 1920 is further configured to: receive an authorization response of the resource server to the UE unreachability information configuration request; or receive a rejection response of the resource server to the UE unreachability information configuration request and a reason for rejection.

In an optional embodiment of the present disclosure, the transceiver module 1920 is further configured to: receive a refresh token sent by the first entity; send an access token request to the first entity, where the access token request is used for requesting the access token; and receive the access token sent by the first entity in response to the access token request.

In an optional embodiment of the present disclosure, the access token may include at least one of the following: an identification of the UE, an identification of the first entity, an identification of the resource requester, an identification of an NEF, an identification of an AEF, a service identification, an identification of a service operation allowed to act on the UE unreachability period information, and an expiration time.

In an optional embodiment of the present disclosure, the resource requester is an AF.

According to the information configuration apparatus provided in the present disclosure, the resource requester can receive the access token sent by the first entity, where the access token includes the UE unreachability period information. In addition, the resource requester can receive the refresh token sent by the first entity, and send the access token request to the first entity for requesting the access token, thereby receiving the access token sent by the first entity in response to the access token request, where the access token includes the UE unreachability period information. The schemes provided in the present disclosure achieve that the core network is allowed to authorize the resource requester to configure the UE unreachability information.

FIG. 21 is a schematic structure diagram of an information configuration apparatus 2100 provided in an embodiment of the present disclosure. The information configuration apparatus 2100 is configured in a resource server.

As shown in FIG. 21, the apparatus 2100 includes a transceiver module 2110. The transceiver module 2110 is configured to: receive a UE unreachability information configuration request sent by a resource requester, where the UE unreachability information configuration request includes an access token, and the access token includes UE unreachability period information; and send, based on the access token, a UE information configuration response to the resource requester.

According to the information configuration apparatus provided in the present disclosure, the resource server can receive the UE unreachability information configuration request sent by the resource requester, where the UE unreachability information configuration information includes the access token, the access token includes the UE unreachability period information, and the resource server sends the UE information configuration response to the resource server based on the access token. The schemes provided in the present disclosure achieve that the core network is allowed to authorize the resource requester to configure the UE unreachability information.

In an optional embodiment of the present disclosure, the transceiver module 2110 is further configured to: send, to the resource requester, an authorization response to the UE unreachability information configuration request; or send, to the resource requester, a rejection response to the UE unreachability information configuration request and a reason for rejection.

According to the information configuration apparatus provided in the present disclosure, the resource server can receive the UE unreachability information configuration request sent by the resource requester, where the UE unreachability information configuration request includes the access token, and the resource server sends the UE information configuration response to the resource server based on the access token. The schemes provided in the present disclosure achieve that the core network is allowed to authorize the resource requester to configure the UE unreachability information.

The embodiments of the present disclosure further provide a communication system. The communication system includes a UE, a first entity, a resource requester, and a resource server. The system includes the information configuration apparatuses, as shown in the aforementioned embodiments of FIGS. 15-21, for executing the information configuration methods as shown in the embodiments of FIGS. 1-14.

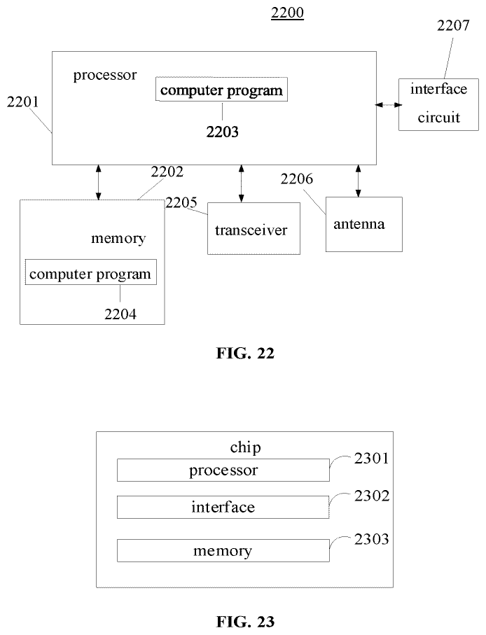

Referring to FIG. 22, FIG. 22 is a schematic structure diagram of a communication device 2200 provided in an embodiment of the present application. The communication device 2200 may be a network device, a UE, or a chip, a chip system or a processor that supports the network device to implement the above methods. The communication device 2200 may also be a chip, a chip system or a processor that supports the UE to implement the above methods. The device may be used for implementing the methods described in the above method embodiments. For details, please refer to the illustration in the above method embodiments.

The communication device 2200 may include one or more processors 2201. The processor 2201 may be a general purpose processor or a specialized processor, etc. For example, the processor 2201 may be a baseband processor or a central processor. The baseband processor may be configured to process communication protocols and communication data. The central processor may be configured to control the communication device (e.g., a base station, a baseband chip, a terminal device, a terminal device chip, a DU, or a CU), execute a computer program, and process data of the computer program.

Optionally, the communication device 2200 may further include one or more memories 2202. The one or more memories 2202 may store a computer program 2204. The processor 2201 executes the computer program 2204 to cause the communication device 2200 to perform the methods described in the above method embodiments. Optionally, the memory 2202 may also store data. The communication device 2200 and the memory 2202 may be provided separately or may be integrated together.

Optionally, the communication device 2200 may further include a transceiver 2205 and an antenna 2206. The transceiver 2205 may be referred to as a transceiver unit, a transceiver device, or a transceiver circuit, etc., and is configured to implement the transceiving functions. The transceiver 2205 may include a receiver and a sender. The receiver may be referred to as a receiving device or a receiving circuit, etc., and is configured to implement a receiving function. The sender may be referred to as a sending device or a sending circuit, etc., and is configured to implement a sending function.

Optionally, the communication device 2200 may further include one or more interface circuits 2207. The interface circuit 2207 is configured to receive a code instruction and transmit the code instruction to the processor 2201. The processor 2201 runs the code instruction to cause the communication device 2200 to perform the methods described in the above method embodiments.

In an implementation, the processor 2201 may include a transceiver configured to implement the receiving and sending functions. For example, the transceiver may be a transceiver circuit, an interface, or an interface circuit. The transceiver circuit, interface, or interface circuit configured to implement the receiving and sending functions may be separate or may be integrated together. The transceiver circuit, interface, or interface circuit described above may be configured for code/data reading and writing, or the transceiver circuit, interface, or interface circuit described above may be configured for signal transmission or delivery.

In an implementation, the processor 2201 may store a computer program 2203. The computer program 2203 is run on the processor 2201 and may cause the communication device 2200 to perform the methods described in the above method embodiments. The computer program 2203 may be solidified in the processor 2201, in which case the processor 2201 may be implemented by hardware.

In an implementation, the communication device 2200 may include a circuit. The circuit may implement the functions of sending, receiving or communicating in the aforementioned method embodiments. The processor and the transceiver described in the present application may be implemented in an integrated circuit (IC), an analog IC, a radio frequency integrated circuit (RFIC), a mixed signal IC, an application specific integrated circuit (ASIC), a printed circuit board (PCB), and an electronic device, etc. The processor and the transceiver may also be manufactured by using various IC process technologies, such as a complementary metal oxide semiconductor (CMOS), a negative channel metal oxide semiconductor (nMetal-oxide-semiconductor, NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The communication device in the description of the above embodiments may be a network device or a UE, but the scope of the communication device described in the present application is not limited thereto. The structure of the communication device may not be limited by FIG. 22. The communication device may be an independent device or may be a part of a large apparatus. For example, the described communication device may be:
(1) an independent integrated circuit (IC), a chip, or a chip system or subsystem;
(2) a set that has one or more ICs, optionally, the IC set may also include a storage component configured to store data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, a vehicle-mounted device, a network device, a cloud device, or an artificial intelligence device, etc.;
(6) others and so on.

For the case where the communication device may be a chip or a chip system, please refer to the schematic structure diagram of the chip shown in FIG. 23. The chip shown in FIG. 23 includes a processor 2301 and an interface 2302. In some embodiments, the number of processors 2301 may be one or more, and the number of interfaces 2302 may be more than one.

Optionally, the chip further includes a memory 2303, where the memory 2303 is configured to store necessary computer programs and data.

Those skilled in the art can also understand that various illustrative logical blocks and steps listed in the embodiments of the present application may be implemented through electronic hardware, computer software, or a combination of the two. Whether such functions are implemented through hardware or software depends on the specific application and design requirements of the overall system. Those skilled in the art can use various methods to implement the described functions for each specific application, but such implementations should not be understood as exceeding the scope of protection of the embodiments of the present application.

The present application further provides a readable storage medium. The readable storage medium stores an instruction. The instruction, when executed by a computer, implements the functions of any of the method embodiments described above.

The present application further provides a computer program product. The computer program product, when executed by a computer, implements the functions of any of the method embodiments described above.

The above embodiments may be implemented in whole or in part by software, hardware, firmware, or any combination thereof. When implemented by using the software, the above embodiments may be implemented in whole or in part in the form of a computer program product. The computer program product includes one or more computer programs. When the computer program is loaded and executed on a computer, a process or a function is produced in whole or in part in accordance with the embodiments of the present application. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another web site, computer, server, or data center. The computer-readable storage medium may be any usable medium to which a computer has access, or a data storage device such as a server or a data center including one or more usable media integration. The usable medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those ordinary skilled in the art can understand that various numerical numbers such as “first” and “second” involved in the present application are only differentiation for the convenience of the description, and are not used for limiting the scope of the embodiments of the present application or indicate the sequential order.

The “at least one” in the present application may also be described as one or more, and the “plurality” may be two, three, four, or more, which are not limited in the present application. In the embodiments of the present application, for one type of technical features, technical features of this type are distinguished by “first”, “second”, “third”, “A”, “B”, “C”, and “D”, etc. The technical features described by “first”, “second”, “third”, “A”, “B”, “C”, and “D”, etc. are in no order of sequence or size.

As used in this article, the terms “machine-readable medium” and “computer-readable medium” refer to any computer program product, device, and/or apparatus (e.g., magnetic disk, optical disk, memory, programmable logic device (PLD)) used for providing machine instructions and/or data to a programmable processor, and include a machine-readable medium that receives machine instructions as machine-readable signals. The term “machine-readable signal” refers to any signal used for providing machine instructions and/or data to the programmable processor.

The system and technology described herein may be implemented in a computing system that includes a backend component (such as a data server), a computing system that includes a middleware component (such as an application server), a computing system that includes a frontend component (such as a user computer with a graphical user interface or a web browser, where the user may interact with the implementation of the system and technology described herein through the graphical user interface or the web browser), or a computing system that includes any combination of such backend component, middleware component, or frontend component. The components of the system may be interconnected through any form or medium of digital data communication (e.g., a communication network). Examples of communication networks include local area networks (LANs), wide area networks (WANs), and the Internet.

The computer system may include a client and a server. The client and the server are generally far apart from each other and typically interact with each other through a communication network. A relationship between the client and the server is generated through computer programs that are run on a corresponding computer and have a client-server relationship with each other.

It should be understood that steps may be reordered, added, or deleted by using various forms of processes shown above. For example, the steps documented in the present disclosure may be performed in parallel, sequentially or in a different order, as long as they can achieve the results desired by the technical solutions disclosed in the present disclosure, which are not limited herein.

Furthermore, it should be understood that various embodiments of the present application may be implemented separately, or in combination with other embodiments as permitted by the scheme.

Those ordinary skilled in the art can realize that the units and algorithm steps of the examples described in combination with the disclosed embodiments in this article may be implemented in electronic hardware, or a combination of computer software and electronic hardware. Whether these functions are executed in hardware or software manners depends on the specific application and design constraints of the technical solution. Professional technicians may use different methods to implement the described functions for each specific application, but such implementations should not be considered beyond the scope of the present application.

Those skilled in the art can clearly understand that for the convenience and conciseness of the description, the specific working processes of the systems, devices, and units described above may refer to the corresponding processes in the aforementioned method embodiments, and will not be repeated here.

The above is only the detailed description of the present application, but the scope of protection of the present application is not limited to this. Any technician familiar with this technical field can easily think of changes or replacements within the technical scope disclosed in the present application, and these changes or replacements should be covered within the scope of protection of the present application. Therefore, the scope of protection of the present application shall be subject to the scope of protection of the claims.

What is claimed is:

1. An information configuration method, characterized in that the method is performed by a user equipment (UE), and the method comprises:
triggering, by performing UE unreachability information configuration authorization through collaborating with a first entity and a resource requester, the first entity to send an access token to the resource requester, wherein the access token comprises UE unreachability period information.

2. The method according to claim 1, wherein the performing the UE unreachability information configuration authorization through collaborating with the first entity and the resource requester comprises:
performing, based on an open authorization (OAuth) 2.0 standard framework, the UE unreachability information configuration authorization through collaborating with the first entity and the resource requester.

3. The method according to claim 1 or 2, wherein the access token comprises at least one of:
an identification of the first entity, an identification of the resource requester, an identification of the UE, an identification of a network exposure function (NEF), an identification of an application programming interface (API) exposing function (AEF), a service identification, an identification of a service operation allowed to act on the UE unreachability period information, and an expiration time.

4. The method according to any one of claims 1 to 3, wherein the method further comprises:
receiving a UE unreachability information configuration authorization request sent by the resource requester, wherein
the UE unreachability information configuration authorization request comprises at least one of: an identification of the resource requester, an identification of the UE, an identification of a requested service, the UE unreachability period information, and an identification of a service operation requested to act on the UE unreachability period information.

5. The method according to claim 4, wherein the performing the UE unreachability information configuration authorization through collaborating with the first entity and the resource requester comprises:
performing, by using an authorization code grant type, real-time authorization on the UE unreachability information configuration authorization request.

6. The method according to any one of claims 1 to 3, wherein the method further comprises:
sending authorization information to the first entity, wherein
the authorization information is used for determining whether the resource requester is capable of configuring the UE unreachability period information for the UE, and the authorization information comprises at least one of: an identification of the resource requester, an identification of the UE, an identification of an allowed service, the UE unreachability period information, an expiration time, and an identification of a service operation allowed to act on the UE unreachability period information.

7. The method according to claim 6, wherein the performing the UE unreachability information configuration authorization through collaborating with the first entity and the resource requester comprises:
performing, by using a client credentials grant type, authorization on a UE unreachability information configuration authorization request.

8. The method according to any one of claims 1 to 7, wherein the UE unreachability period information comprises at least one of: information about a maximum latency, information about a maximum response, information about time when the UE is provided with signal coverage, and information about time when the UE is out of signal coverage.

9. An information configuration method, characterized in that the method is performed by a first entity, and the method comprises:
sending, by performing user equipment (UE) unreachability information configuration authorization through collaborating with a resource requester and a UE, an access token to the resource requester, wherein the access token comprises UE unreachability period information.

10. The method according to claim 9, wherein the performing the UE unreachability information configuration authorization through collaborating with the resource requester and the UE comprises:
performing, based on an open authorization (OAuth) 2.0 standard framework, the UE unreachability information configuration authorization through collaborating with the resource requester and the UE.

11. The method according to claim 9 or 10, wherein the sending, by performing the UE unreachability information configuration authorization through collaborating with the resource requester and the UE, the access token to the resource requester comprises:
sending, based on an authorization code grant type, the access token to the resource requester.

12. The method according to any one of claims 9 to 11, wherein the method further comprises:
receiving authorization information sent by the UE, and receiving a UE unreachability information configuration authorization request sent by the resource requester; wherein
the sending, by performing the UE unreachability information configuration authorization through collaborating with the resource requester and the UE, the access token to the resource requester comprises:
sending the access token to the resource requester through performing based on the authorization information, by using a client credentials grant type, authorization on the UE unreachability information configuration authorization request; and
the authorization information is used for determining whether the resource requester is capable of configuring the UE unreachability information for the UE, and the authorization information comprises at least one of: an identification of the resource requester, an identification of the UE, an identification of an allowed service, the UE unreachability period information, an identification of a service operation allowed to act on the UE unreachability period information, and an expiration time.

13. The method according to any one of claims 9 to 12, wherein the method further comprises:
sending a refresh token to the resource requester;
receiving an access token request sent by the resource requester, wherein the access token request is used for requesting the access token; and
sending, in response to the access token request, the access token to the resource requester.

14. The method according to any one of claims 9 to 13, wherein the access token comprises at least one of:
an identification of the first entity, an identification of the resource requester, an identification of the UE, an identification of a network exposure function (NEF), an identification of an application programming interface (API) exposing function (AEF), a service identification, an identification of a service operation allowed to act on the UE unreachability period information, and an expiration time.

15. An information configuration method, characterized in that the method is performed by a resource requester, and the method comprises:
obtaining an access token by performing user equipment (UE) unreachability information configuration authorization through collaborating with a first entity and a UE, wherein the access token comprises UE unreachability period information.

16. The method according to claim 15, wherein the performing the UE unreachability information configuration authorization through collaborating with the first entity and the UE comprises:
performing, based on an open authorization (OAuth) 2.0 standard framework, the UE unreachability information configuration authorization through collaborating with the first entity and the UE.

17. The method according to claim 15 or 16, wherein the method further comprises:
sending a UE unreachability information configuration authorization request to the UE, wherein the UE unreachability information configuration authorization request comprises at least one of: an identification of the resource requester, an identification of the UE, an identification of a requested service, the UE unreachability period information, and an identification of a service operation requested to act on the UE unreachability period information.

18. The method according to claim 15 or 16, wherein the method further comprises:
sending a UE unreachability information configuration authorization request to the first entity.

19. The method according to any one of claims 15 to 18, wherein the method further comprises:
sending a UE unreachability information configuration request to a resource server, wherein the UE unreachability information configuration request comprises the access token; and
receiving a UE information configuration response sent by the resource server.

20. The method according to claim 19, wherein the receiving the UE information configuration response sent by the resource server comprises:
receiving an authorization response of the resource server to the UE unreachability information configuration request; or
receiving a rejection response of the resource server to the UE unreachability information configuration request and a reason for rejection.

21. The method according to any one of claims 15 to 20, wherein the method further comprises:
receiving a refresh token sent by the first entity;
sending an access token request to the first entity, wherein the access token request is used for requesting the access token; and
receiving the access token sent by the first entity in response to the access token request.

22. The method according to any one of claims 15 to 21, wherein the access token comprises at least one of:
an identification of the first entity, an identification of the resource requester, an identification of the UE, an identification of a network exposure function (NEF), an identification of an application programming interface (API) exposing function (AEF), a service identification, an identification of a service operation allowed to act on the UE unreachability period information, and an expiration time.

23. The method according to any one of claims 15 to 22, wherein the resource requester is an application function (AF).

24. An information configuration method, characterized in that the method is performed by a resource server, and the method comprises:
receiving a user equipment (UE) unreachability information configuration request sent by a resource requester, wherein the UE unreachability information configuration request comprises an access token, and the access token comprises UE unreachability period information; and
sending, based on the access token, a UE information configuration response to the resource requester.

25. The method according to claim 24, wherein the sending, based on the access token, the UE information configuration response to the resource requester comprises:
sending, to the resource requester, an authorization response to the UE unreachability information configuration request; or
sending, to the resource requester, a rejection response to the UE unreachability information configuration request and a reason for rejection.

26. An information configuration apparatus, characterized in that the apparatus is configured in a user equipment (UE), the apparatus comprises an authorization module, and the authorization module is configured to:
trigger, by performing UE unreachability information configuration authorization through collaborating with a first entity and a resource requester, the first entity to send an access token to the resource requester, wherein the access token comprises UE unreachability period information.

27. An information configuration apparatus, characterized in that the apparatus is configured in a first entity, the apparatus comprises an authorization module, and the authorization module is configured to:
send, by performing user equipment (UE) unreachability information configuration authorization through collaborating with a resource requester and a UE, an access token to the resource requester, wherein the access token comprises UE unreachability period information.

28. An information configuration apparatus, characterized in that the apparatus is configured in a resource requester, the apparatus comprises an authorization module, and the authorization module is configured to:
obtain an access token by performing user equipment (UE) unreachability information configuration authorization through collaborating with a first entity and a UE, wherein the access token comprises UE unreachability period information.

29. An information configuration apparatus, characterized in that the apparatus is configured in a resource server, the apparatus comprises a transceiver module, and the transceiver module is configured to:
receive a user equipment (UE) unreachability information configuration request sent by a resource requester, wherein the UE unreachability information configuration request comprises an access token, and the access token comprises UE unreachability period information, and
send, based on the access token, a UE information configuration response to the resource requester.

30. A communication device, comprising:
a transceiver;
a memory; and
a processor, connected to the transceiver and the memory respectively, and configured to, through executing a computer-executable instruction in the memory, control transceiving of a wireless signal of the transceiver, and be capable of implementing the method according to any one of claims 1-25.

31. A computer storage medium, wherein the computer storage medium stores a computer-executable instruction, and the computer-executable instruction, when executed by a processor, is capable of implementing the method according to any one of claims 1-25.

32. A communication system, characterized in comprising a user equipment (UE), a resource requester, a first entity, and a resource server, wherein the UE is configured to perform the method according to any one of claims 1 to 8;
the first entity is configured to perform the method according to any one of claims 9 to 14;
the resource requester is configured to perform the method according to any one of claims 15 to 23; and
the resource server is configured to perform the method according to any one of claims 24 to 25.
